(19) United States
(12) Patent Application Publication
(10) Pub. No.: US 2022/0338646 A1
(43) Pub. Date: Oct. 27, 2022

(54) DISPLAY SYSTEM

(71) Applicant: McMullen Display Ventures LLC, McKinney, TX (US)

(72) Inventors: Thomas James McMullen, McKinney, TX (US); Michael Woodford Freitas, Plano, TX (US); Michael Kerry Bristow, Shawnee, KS (US)

(73) Assignee: McMullen Display Ventures LLC, McKinney, TX (US)

(21) Appl. No.: 17/731,064

(22) Filed: Apr. 27, 2022

Related U.S. Application Data
(60) Provisional application No. 63/180,486, filed on Apr. 27, 2021.

(51) Int. Cl. A47F 7/00

(52) U.S. Cl. CPC A47F 7/00

(57) ABSTRACT

A display system has a wall having a profile representative of but larger than a profile of a collectible item, the wall has an exterior surface and at least one of an aperture and a concavity, wherein the at least one aperture and concavity has a shape configured to receive the collectible item therethrough or therein, respectively. A method of display includes providing a wall having a profile representative of but larger than a profile of a collectible item, the wall having an exterior surface and providing an aperture or concavity in the wall wherein the aperture or concavity is shaped to at least partially receive the collectible item therethrough or therein, respectively.

### BACKGROUND

Memorabilia, commemorative items, travel souvenirs, and similar collectible items are often curated and collectively displayed. However, some items are more easily displayed than others and some existing display systems are not generally visually appealing or striking in their own right.

### BRIEF DESCRIPTION OF THE DRAWINGS

FIG. 1 is an oblique view of a display system according to an embodiment of this disclosure.

FIG. 2 is a top view of an upper mount portion of the display system FIG. 1.

FIG. 3 is a side cross-sectional view of the upper mount portion of FIG. 2.

FIG. 4 is a side view of the upper mount portion of FIG. 2.

FIG. 5 is an oblique view of the upper mount portion of FIG. 2.

FIG. 6 is an oblique view of a retainer insert of the display system of FIG. 1.

FIG. 7 is a side view of the retainer insert of FIG. 6.

FIG. 8 is another side view of the retainer insert of FIG. 6.

FIG. 9 is a bottom view of the retainer insert of FIG. 6.

FIG. 10 is an oblique view of a base of the display system of FIG. 1.

FIG. 11 is a top view of the base of FIG. 10.

FIG. 12 is a side view of the base of FIG. 10.

FIG. 13 is an oblique bottom view of a pedestal of the display system of FIG. 1.

FIG. 14 is a side view of the pedestal of FIG. 13.

FIG. 15 is a bottom view of the pedestal of FIG. 13.

FIG. 16 is a side view of an alternative embodiment of a display system according to this disclosure.

FIG. 17 is a top view of the display system of FIG. 16.

FIG. 18 is in oblique exploded view of the display system of FIG. 16.

FIG. 19 is a flowchart of a method of display according to an embodiment of this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

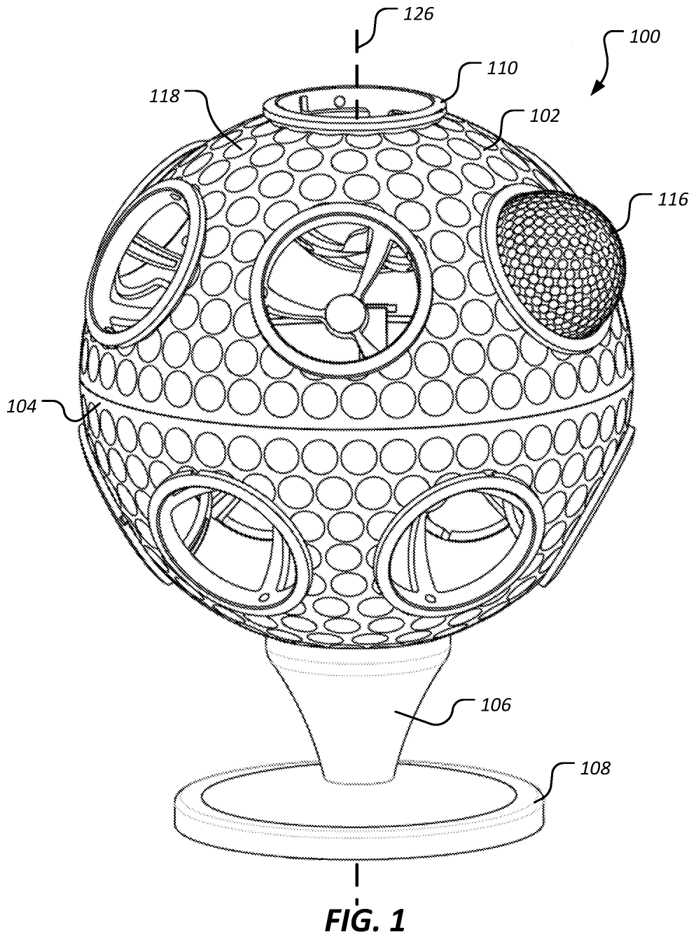

Referring now to FIG. 1, a display system 100 is shown. In this embodiment, display system 100 generally comprises an upper mount portion 102, a lower mount portion 104 connected to the upper mount portion 102, a golf tee shaped pedestal 106 connected to a lower portion of the lower mount portion 104, and a base 108 connected to a lower portion of the pedestal 106. Display system 100 further comprises retainer inserts 110 configured for being selectively received within upper apertures 112 of upper mount portion 102 and lower apertures 114 of lower mount portion 104.

Most generally, display system 100 is configured not only to appear as a golf ball supported by a golf tee, but also to selectively receive and retain golf balls 116 within upper apertures 112 and lower apertures 114. In this embodiment, the upper mount portion 102 and the lower mount portion 104 are configured to selectively couple to each other to form the shape of an enlarged golf ball. In addition to the upper apertures 112 and lower apertures 114, the upper mount portion 102 and the lower mount portion 104 comprise dimples 118 in a pattern similar to dimples of a golf ball to further give the display system 100 the appearance of a golf ball on a golf tee.

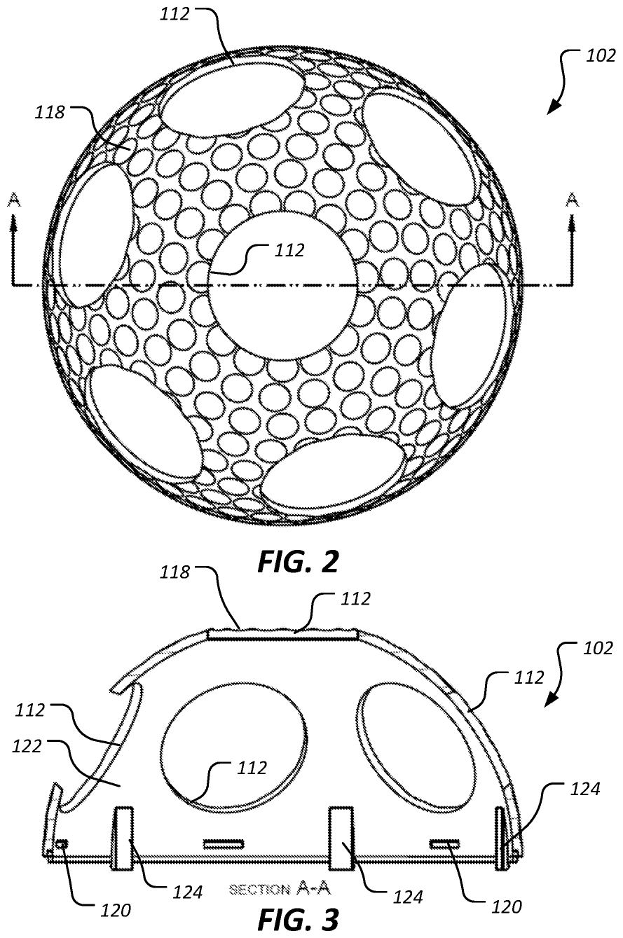

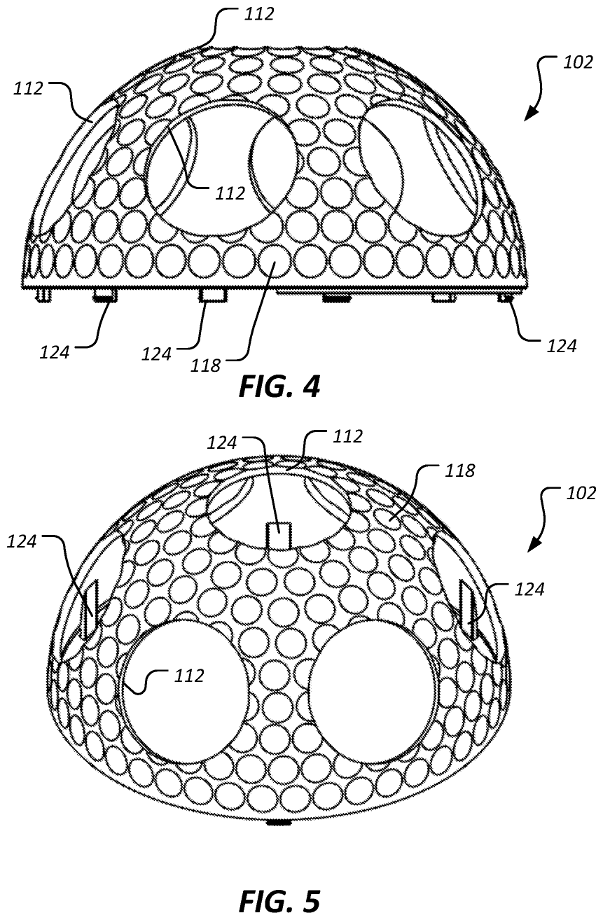

Referring now to FIGS. 2-5, the upper mount portion 102 is shown in isolation. In this embodiment, upper mount portion 102 comprises a general hemispherical shape. Upper mount portion 102 further comprises an angular array of slot like concavities 120 disposed near a largest diameter portion of an inner surface 122. Upper mount portion 102 also comprises an angular array of hook tabs 124 extending beyond the largest diameter portion of the inner surface 122 and generally beyond an axial length of the remainder of the upper mount portion 102. In this embodiment, the lower mount portion 104 is substantially identical to the upper mount portion 102 so that when properly aligned the hook tabs 124 of the upper mount portion 102 can engage the concavities 120 of the lower mount portion 104 and the hook tabs of the lower mount portion 104 can engage the concavities 120 of the upper mount portion, thereby substantially forming a spherical rigid object. In this embodiment, an upper aperture 112 is located substantially coaxially with a central vertical axis 126 of the display system 100. Additional upper apertures 112 are angularly disposed and equidistant angular array about the vertical axis 126. However, in alternative embodiments, apertures may be located differently but nonetheless configured for receiving a retainer insert 110.

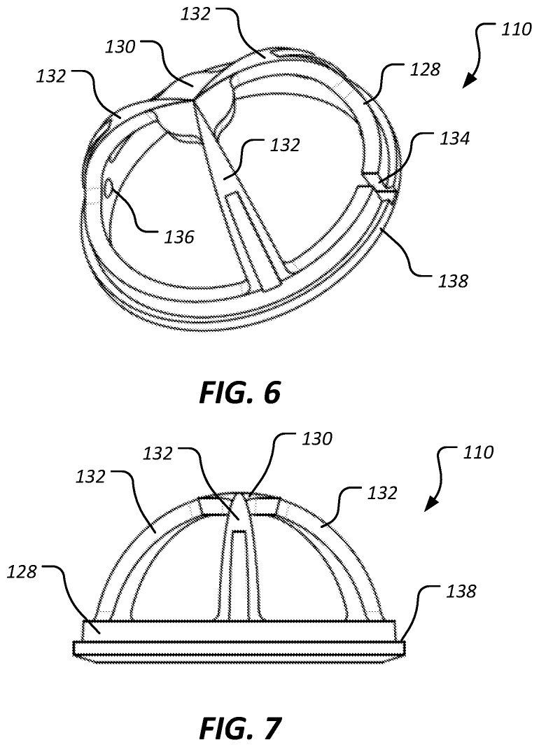

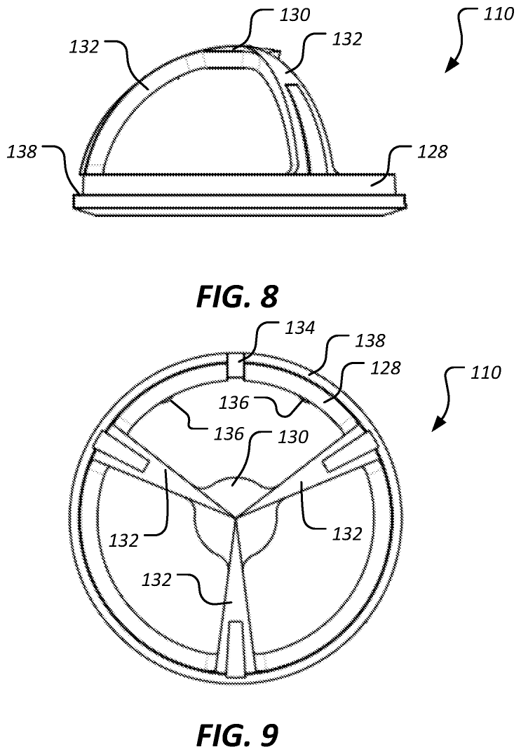

Referring now to FIGS. 6-9, retainer insert 110 is shown in isolation. Retainer insert 110 generally comprises a ring 128, a backstop 130, and a plurality of bowl supports 132 that join ring 128 to backstop 130. Collectively, ring 128 backstop 130, and bowl supports 132 define a retention space generally bounded by ring 128, backstop 130, and bowl supports 132 that is shaped to receive at least a portion of a golf ball. Retainer insert 110 further comprises a flexure slot 134 formed within ring 128 to allow bending of ring 128 during insertion into upper apertures 112 or lower apertures 114. Ring 128 is further configured to comprise at least one protrusion 136 disposed to extend from ring 128 toward vertical axis 126. Protrusions 136 are configured to complement and be received at least partially within dimples of a golf ball so that retainer insert 110 can exert and improve retention capability to hold a golf ball within the retention space. Ring 128 is further configured to comprise an overhang lip 138 to prevent retainer insert 110 from completely passing through upper apertures 112 and lower apertures 114 when inserted.

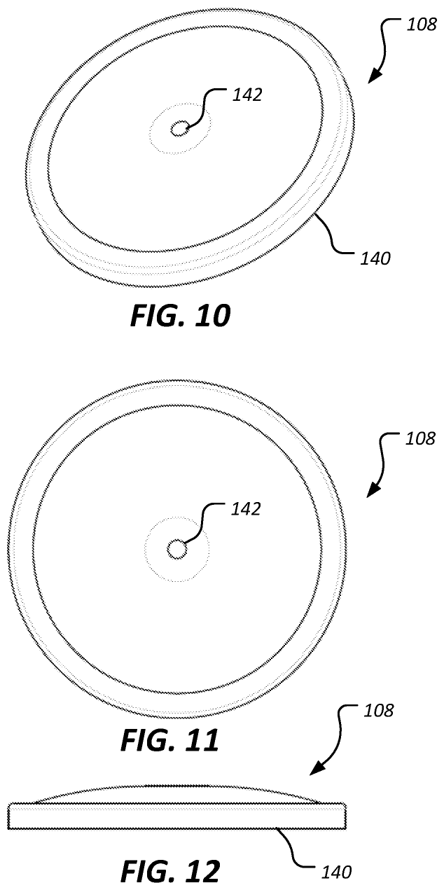

Referring now to FIGS. 10-12, base 108 is shown in isolation. Base 108 generally comprises a disk-shaped structure having a substantially planar bottom 140 and a mounting hole 142. In this embodiment, a lower portion of pedestal 106 can be selectively received within mounting hole 142 to selectively couple pedestal 106 to base 108, such as by an interference fit.

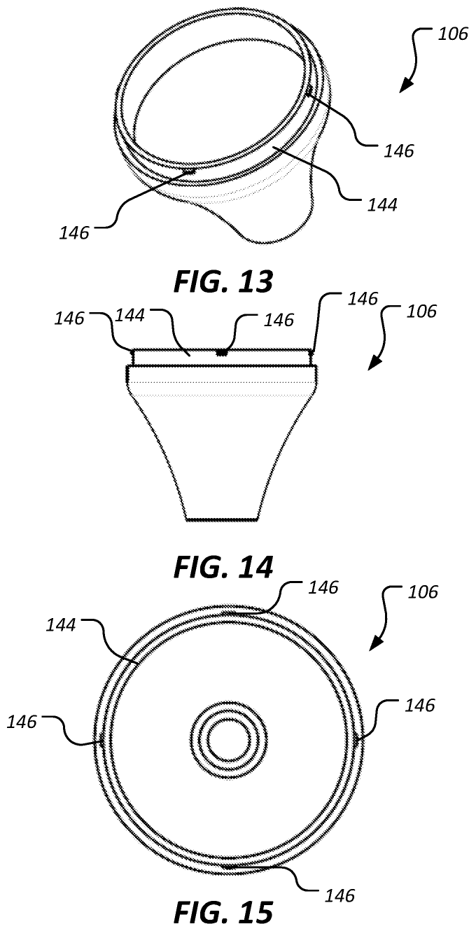

Referring now to FIGS. 13-15, pedestal 106 is shown in isolation. Pedestal 106 is generally formed in the shape of an upper longitudinal section of a golf tee. Extending from the golf tee shape is a mounting wall 144 comprising tabs 146 extending from mounting wall 144 away from vertical axis 126. In this embodiment, pedestal 106 can be selectively secured to lower mount portion 104 by inserting mounting wall 144 into a centrally located lower aperture 114 so that tabs 146 engage concavities 120, thereby selectively coupling lower mount portion 104 to pedestal 106.

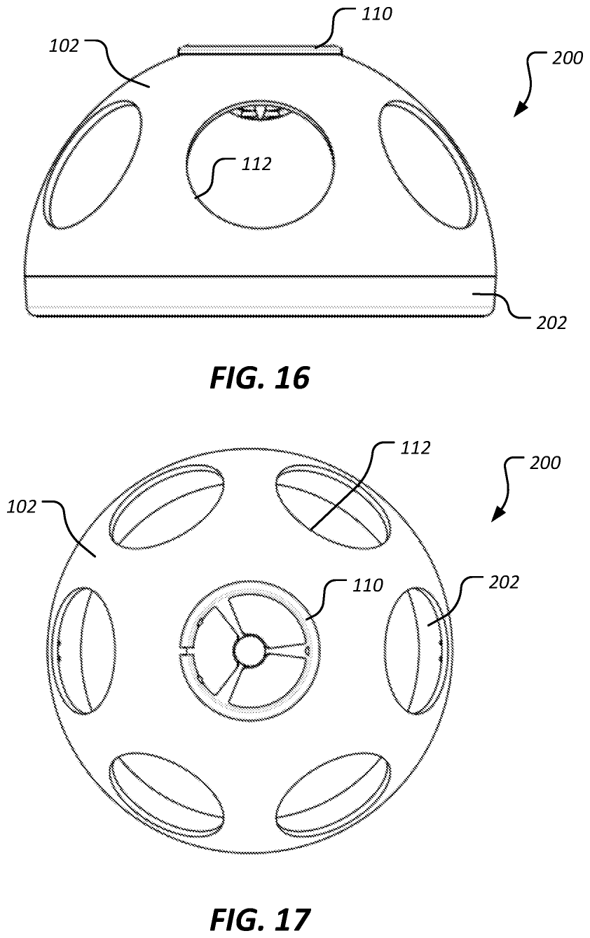

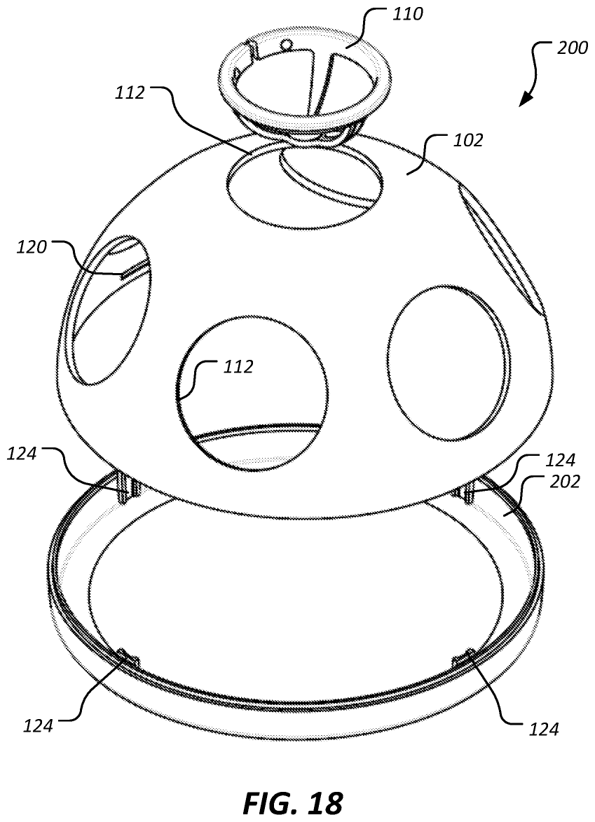

Referring now to FIGS. 16-18, an alternative embodiment of a display system 200 is shown. Display system 200 is substantially similar to display system 100 but does not comprise the lower mount portion 104, pedestal 106, and base 108. Instead, display system 200 further comprises a base ring 202 configured for selective attachment to a lower end of upper mount portion 102 so that display system 200 forms a generally hemispherical overall golf ball shape while being able to receive and retain golf balls in substantially the same manner as display system 100 is able to receive and retain golf balls.

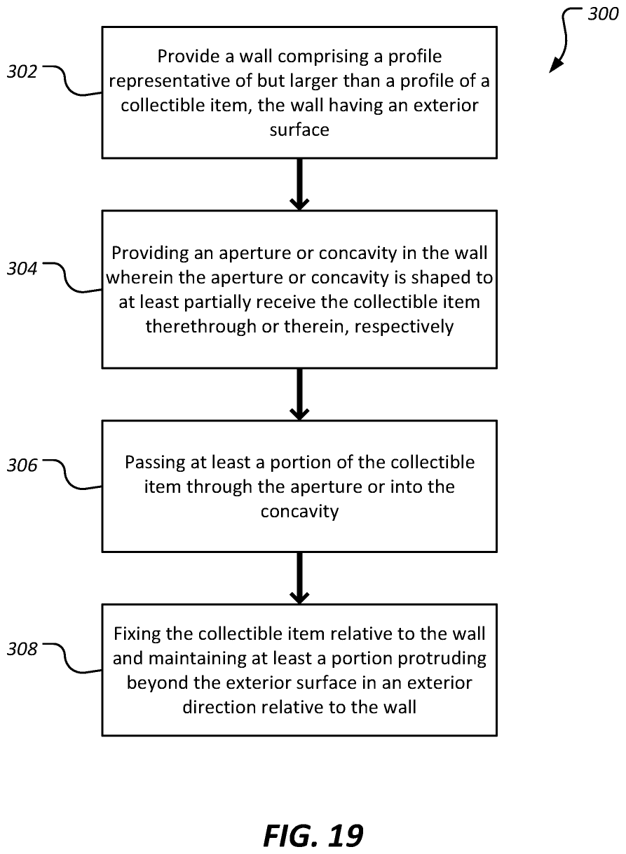

Referring now to FIG. 19, a flowchart of a method of display 300 is shown. Method 300 can begin at block 302 by providing a wall, such as upper mount portion 102, that has a profile that is representative of but larger than a profile of a collectible item, such as a profile of a golf ball 116. The wall provided comprises an exterior surface. The method 300 can progress at block 304 by providing an aperture or concavity in the wall wherein the aperture or concavity is shaped to at least partially receive the collectible item therethrough or therein, respectively. Method 300 can progress at block 306 by passing at least a portion of the collectible item through the aperture or into the concavity. The method 300 can progress at block 308 by fixing the collectible item relative to the wall and maintaining at least a portion of the collectible item in a position that protrudes beyond the exterior surface in an exterior direction relative to the wall, such as in a direction opposite to a direction used to insert the collectible item through the aperture or into the concavity.

It will be appreciated that the shapes, sizes, and locations of various features disclosed herein, such as, but not limited to the retainer inserts and complementarily shaped apertures, can be different in alternative embodiments. For example, in alternative embodiments, a collectible item can comprise a football shape, soccer ball shape, hockey puck, or any other suitable shape and the associated wall and aperture or concavity can comprise concomitant shapes and profiles that allow the collectible item shaped wall to support and carry the collectible item in a collectible item shaped aperture or concavity. Further, in alternative embodiments, one or more of the components may be configured to allow relative rotation about the vertical axis. In some cases, the upper mount portion may be rotatable relative to the lower mount portion using bearings or simply a loose fit. In other cases, the lower mount portion may be rotatable relative to the pedestal. Similarly, the pedestal may be rotatable relative to the base.

Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{I}, and an upper limit, Rᵤ, is disclosed, any number falling within the range is specifically disclosed. In particular, the following numbers within the range are specifically disclosed: R=R₁+k*(Ru-R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A display system, comprising:
a wall comprising a profile representative of but larger than a profile of a collectible item, the wall comprising an exterior surface and at least one of an aperture and a concavity, wherein the at least one aperture and concavity comprises a shape configured to receive the collectible item therethrough or therein, respectively.

2. The display system of claim 1, wherein the collectible item is a golf ball.

3. The display system of claim 2, wherein the wall comprises dimples representative of golf ball dimples.

4. The display system of claim 1, wherein the wall comprises a hemispherical shape.

5. The display system of claim 4, wherein the at least one of an aperture and a concavity is disposed along a central vertical axis of the display system.

6. The display system of claim 4, wherein a plurality of the at least one aperture and concavity are disposed in an angular array about a central vertical axis of the display system.

7. The display system of claim 1, further comprising:
a second wall comprising a profile representative but larger than a profile of the collectible item.

8. The display system of claim 7, further comprising:
at least one of an aperture and concavity comprising a shape configured to receive the collectible item therethrough or therein, respectively.

9. The display system of claim 8, wherein a plurality of the at least one aperture and concavity of the second wall are disposed in an angular array about a central vertical axis of the display system.

10. The display system of claim 1, further comprising:
a rotatable base configured to carry the wall.

12. The display system of claim 1, further comprising:
a retainer insert configured to be carried by the wall and at least partially disposed within the at least one of an aperture and a concavity.

13. The display system of claim 12, wherein the retainer insert is configured to receive and selectively retain the collectible item relative to the wall.

14. A method of display, comprising:
providing a wall comprising a profile representative of but larger than a profile of a collectible item, the wall having an exterior surface; and
providing an aperture or concavity in the wall wherein the aperture or concavity is shaped to at least partially receive the collectible item therethrough or therein, respectively.

15. The method of claim 14, further comprising:
passing at least a portion of the collectible item through the aperture or into the concavity.

16. The method of claim 15, further comprising:
fixing the collectible item relative to the wall and maintaining at least a portion protruding beyond the exterior surface in an exterior direction relative to the wall.

17. The method of claim 16, further comprising:
disposing a retainer insert between the wall and the collectible item.

18. The method of claim 17, further comprising:
carrying the wall on a rotatable base.

19. The method of claim 14, wherein the collectible item is a golf ball.
